(19) United States
(12) Patent Application Publication
(10) Pub. No.: US 2003/0110713 A1
(43) Pub. Date: Jun. 19, 2003

(54) Method and apparatus for the prevention of ice dams

(76) Inventor: John U. Fauster, Grosse Pointe Farms, MI (US)

Correspondence Address: HARNESS, DICKEY & PIERCE, P.L.C., P.O. BOX 828, BLOOMFIELD HILLS, MI, 48303, US

(21) Appl. No.: 10/321,081

(22) Filed: Dec. 16, 2002

Related U.S. Application Data
(60) Provisional application No. 60/342,805, filed on Dec. 19, 2001.

(51) Int. Cl. E04D 13/00; A23K 1/175; A23L 1/30; E04C 2/00

(52) U.S. Cl. 52/24; 52/11; 52/12; 52/13; 52/15; 52/25; 426/74; 426/806

(57) ABSTRACT

A permeable retaining member defines a chamber therein. The permeable retaining members has an opening to the chamber. The chamber of the retainer member is filled through the opening with a melting substance and the opening is closed. The melting substance is adapted to permeate through the retaining member for melting proximate ice in a gutter and preventing ice dams on roofs.

### CROSS-REFERENCE TO RELATED APPLICATION

This application claims priority to a provisional patent application which has been assigned U.S. Serial No. 60/342,805, filed Dec. 19, 2001.

### FIELD OF THE INVENTION

The present invention generally pertains to the prevention of ice dams on roofs. More specifically, but without restriction to the particular embodiment and/or use which is shown and described for purposes of illustration, the present invention relates to a method and apparatus for the prevention of ice dams which incorporates a retaining member having a melting substance disposed therein, the melting substance adapted to permeate through the retaining member for melting proximate ice.

### BACKGROUND OF THE INVENTION

Ice dams are areas of ice buildup along the perimeter of a roof caused from the melting and subsequent freezing of snow and/or ice arranged on the roof. Ice dams are generally formed when a roof surface is above 32 degrees Fahrenheit and the outside temperature is below 32 degrees Fahrenheit. These conditions are favorable to encourage snow that may have collected on a roof to slowly melt and reform as ice on a perimeter of a roof.

Ice dams are particularly unfavorable because they add unwanted weight along a roofline which may promote roof fatigue leading to roof damage or failure. In addition, ice dams act as a barrier to collect more snow and ice on adjacent areas along the roof. Such a pattern makes the problem progressively worse.

Among current solutions to this problem include reinsulating the home, ventilation, chopping the ice or shoveling the snow off the roof. While such arrangements are satisfactory for their intended purpose, a need exists to develop simpler, more cost effective alternatives that provide the desired function while advancing the art.

### SUMMARY OF THE INVENTION

It is a general object of the present invention to provide a method and an apparatus which prevents the formation of ice dams.

In one form, the present invention provides a permeable retaining member defining a chamber therein. A melting substance is disposed within the chamber, the melting substance adapted to permeate through the retaining member for melting proximate ice.

In another form, the present invention provides a method for preventing ice dams of roofs. In a first general step, a permeable retaining member having an opening is provided. In a second general step, the retaining member is filled through the opening with a melting substance. In a third general step, the opening is closed. In a fourth general step, the retaining member is placed in a predetermined location, the melting substance adapted to permeate through the retaining member for melting proximate ice.

Additional benefits and advantages of the present invention will become apparent to those skilled in the art to which this invention relates from a reading of the subsequent description of the preferred embodiment and the appended claims, taken in conjunction with the accompanying drawings.

### BRIEF DESCRIPTION OF THE DRAWINGS

FIG. 1 is an environmental view of an apparatus for the prevention of ice dams constructed in accordance with the teachings of a preferred embodiment of the present invention, the apparatus shown operatively positioned within a gutter of a home.

FIG. 2 is an enlarged prospective view of an apparatus for the prevention of ice dams of the present invention.

FIG. 3 is a cross-sectional view taken along line 3-3 of FIG. 2.

FIG. 4 is a view of the general steps of the preferred method of the present invention.

### DETAILED DESCRIPTION OF THE PREFERRED EMBODIMENT

With general reference to FIGS. 1-3, an apparatus for the prevention of ice dams constructed in accordance with the teachings of a preferred embodiment of the present invention will be described. With particular reference to FIG. 1, there is shown an apparatus for the prevention of ice dams 10 in accordance with a preferred embodiment of the present invention.

The apparatus for the prevention of ice dams 10 of the present invention is illustrated to generally include a permeable retaining member or sleeve 12 and a material 14 disposed therein for the melting device. The sleeve 12 is comprised of a generally flexible mesh-like material which allows the material 14 to permeate therethrough to melt ice and snow build-up. In one particular application, the sleeve is made of polypropelyne. It will be appreciated, however, that sleeve 12 may be comprised of other suitable flexible permeable materials, including but not limited to cotton.

In one particular application, the material 14 for the melting of ice comprises sodium acetate. One suitable material is commercially available from Cryotech Deicing Technology of Fort Madison, Iowa under the trademark NAAC. The sodium acetate comprises a plurality of spherical pellets. The spherical pellets provide a configuration which minimizes dust and results in even spread patterns. Those skilled in the art will readily appreciate that sodium acetate is preferred, although alternate materials may be incorporated. The melting process is an exothermic reaction that initiates upon the introduction of water to provide heat.

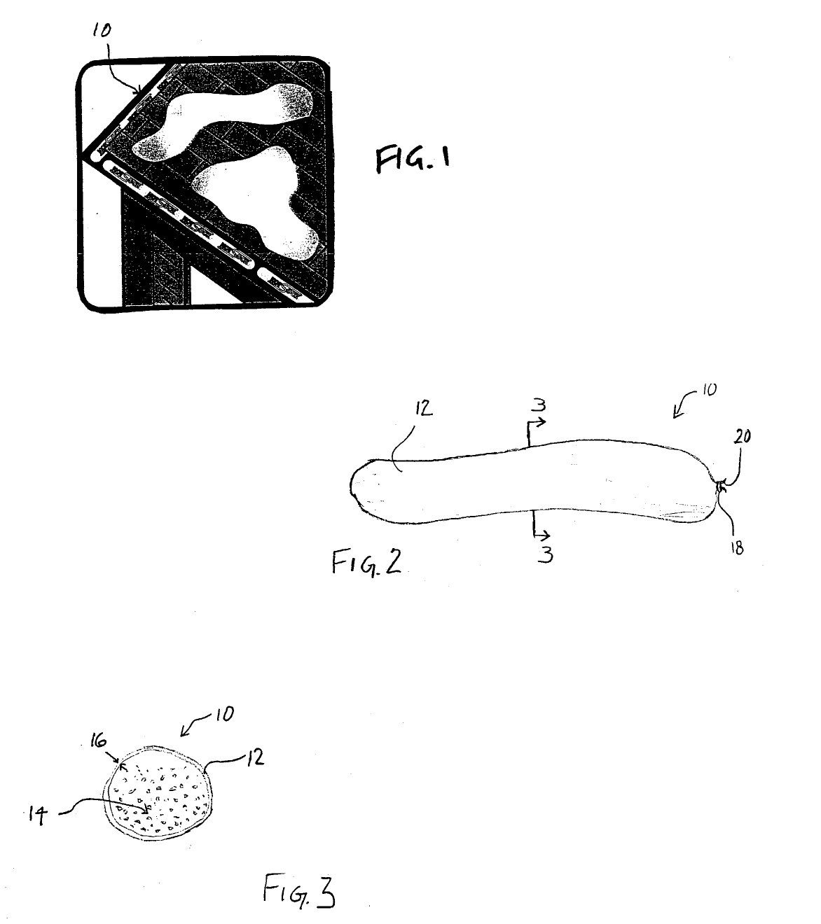

Turning now to FIGS. 2 and 3, sleeve 12 comprises a generally cylindrical sock-like retaining member. In one particular application, sleeve 12 is four (4) feet long and three (3) inches in diameter. Those skilled in the art will appreciate that these dimensions could vary considerably, and that the important consideration is that the apparatus 10 is configured to be suitably placed in an area of interest such as a gutter around the perimeter of a roof. Similarly, sleeve thickness 16 is preferably configured to be minimal so as to provide structural rigidity and workability while providing necessary permeability.

During assembly, sleeve 12 includes an opening 20 for disposing material 14 therethrough. When sufficient material 14 is disposed within sleeve 12, a closure member 18 such as a tie strap, staple or other suitable device is clamped or otherwise secured around opening 20 to seal sleeve 12. Preferably, when sleeve 12 has effectively exhausted its supply of material 14, the sleeve 12 is removed and replaced with a new unused sleeve 12.

In a second application, closure member 18 may be removed and material 14 may be sprinkled onto areas of interest such as driveways or sidewalks to help prevent ice and snow buildup.

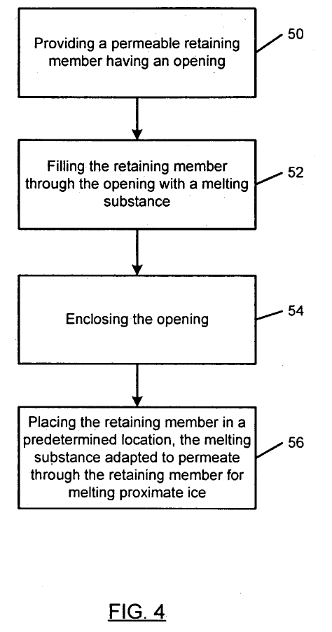

Referring now to FIG. 4, in a first general step 50 the preferred method of the present invention provides a permeable retaining member 12 having an opening.

In a second general step 52, the retaining member of the present invention is filled through the opening with a melting substance 14.

In a third general step 54, the opening 20 of the retaining member 12 is enclosed.

In a fourth general step 56, the retaining member 12 of the present invention is placed in a predetermined location. The melting substance 14 is adapted to permeate through the retaining member for melting proximate ice.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. An apparatus for preventing ice dams on roofs, the apparatus comprising:
a permeable retaining member defining a chamber therein; and
a melting substance disposed within the chamber, the melting substance adapted to permeate through the retaining member for melting proximate ice.

2. A method for preventing ice dams on roofs, the method comprising the steps of:
providing a permeable retaining member having an opening;
filling the retaining member through the opening with a melting substance;
enclosing the opening; and
placing the retaining member in a predetermined location, the melting substance adapted to permeate through the retaining member for melting proximate ice.
